(19) United States
(12) Patent Application Publication
(10) Pub. No.: US 2015/0310748 A1
(43) Pub. Date: Oct. 29, 2015

(54) ACTIVE TRAINING PLATFORM AND ENVIRONMENT

(71) Applicants: Abram Spiegelman, Woodinville, CA (US); Scott Searle, Kirkland, CA (US)

(72) Inventors: Abram Spiegelman, Woodinville, CA (US); Scott Searle, Kirkland, CA (US)

(73) Assignee: ENTRAIN CORPORATION, Woodenville, WA (US)

(21) Appl. No.: 14/259,202

(22) Filed: Apr. 23, 2014

(51) Int. Cl. G09B 5/00

(52) U.S. Cl. CPC G09B 5/00

(57) ABSTRACT

The invention allows for the ability to gather data, assess, test, certify, and provide feedback in any live environment (including, but not limited to, an application, a web application, or a physical environment), in real time, via any data interface (such as an API). This is accomplished by establishing a real-time link between the live environment and an ActiveTraining engine. The ActiveTraining engine has many different applications, including, but not limited to, training, certification, HR screening, skills assessment, and product evaluation. By delivering a live environment to an end-user, and by tracking the users activity in real-time and providing meaningful feedback to the user, it can deliver a unique experience that not only allows a user to immediately expand know-how and practical use of the environment, but also reports back real-time data that lets it analyze many different elements of the user's interactions with the environment.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

The current invention relates to an active training platform and environment, in more particularly having the live environment and an ActiveTraining engine.

2. Background

The line between training and using an application or environment is becoming blurred. With the intent of being illustrative and not limiting, the invention allows users to learn, train and become certified by using a live environment. It gives administrators a unique view into how users achieve tasks and goals and assess skill levels accordingly. It allows for the delivery, in real-time, of relevant, guided assistance and help to get the user to a stated objective or skill level. Live environments are changing all the time. Generating and maintaining associated training and managing user interaction and learning is becoming more costly.

There exists a need for an engine, that as a product/environment changes, the learning environment is updated automatically.

There is still room for improvement in the art.

### SUMMARY OF THE INVENTION

The current invention is a platform that allows for the ability to gather data, assess, test, certify, and provide feedback in any live environment (including, but not limited to, an application, a web application, or a physical environment), in real time, via any data interface (such as an API). The inventors accomplished this by establishing a real-time link between the live environment and the ActiveTraining engine. This link is novel and unique to this invention.

The ActiveTraining engine has many different applications, including, but not limited to, training, certification, product evaluation, and screening/skills-assessment. By delivering a live environment to an end-user, and by tracking the users activity in real-time and providing meaningful feedback to the user, the system can deliver a unique experience that not only allows a user to immediately expand know-how and practical use of the environment, but also reports back real-time data that lets users analyze many different elements of the user's interactions with the environment.

### BRIEF DESCRIPTION OF THE DRAWINGS

Without restricting the full scope of this invention, the preferred form of this invention is illustrated in the following drawings in which:

FIG. 1 shows a computer system on which the system may process;

FIG. 2 displays the architecture of the system.

### BRIEF DESCRIPTION OF THE PREFERRED EMBODIMENTS

There are a number of significant design features and improvements incorporated within the invention.

The invention's architecture is as follows. At the core of its platform 1 is an ActiveTraining engine. The ActiveTraining engine will plug in and adapt to different scenarios. This is accomplished by establishing a real-time link between the live environment and the ActiveTraining engine. By delivering a live environment to an end-user, and by tracking the users activity in real-time and providing meaningful feedback to the user, the platform 1 can deliver a unique experience that not only allows a user to immediately expand know-how and practical use of the environment, but also reports back real-time data that lets it analyze many different elements of the user's interactions with the environment.

The platform 1 is set to run a one or on a number of on premise or cloud-based computing devices or servers 10. A computing device on which the present invention can run could be comprised of a CPU, Hard Disk Drive, Keyboard, Monitor, CPU Main Memory and a portion of main memory where the system resides and executes. A printer can also be included. Any general purpose computer or server with an appropriate amount of storage space is suitable for this purpose. Computer Devices like this are well known in the art and are not pertinent to the invention. The system can also be written in a number of different languages and run on a number of different operating systems and platforms. The system is network based and works on an Internet, Intranet and/or Wireless network basis as well as a standalone system.

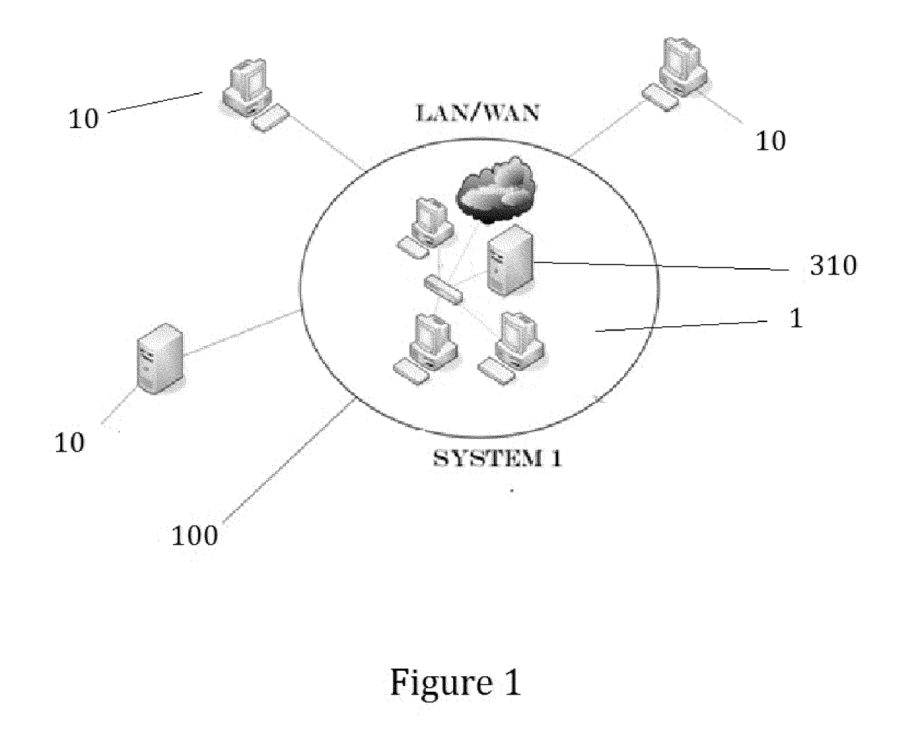

As shown in FIG. 1, the users 10 would access the platform 1 through a network, WAN, LAN or Internet 100. The system's software would reside in the system's memory 310. There are a number of different components of the system 1, these are described below.

The platform 1 uses one or more memory means such as a standard hard drive or any other standard data storage device to store the data. The databases are stored in this memory and the platform 1 changes the system's memory 310 as it processes.

The platform 1 has a plug-in architecture. Different facets of the system interface and interact with the user, with the live environment (presentation of the live environment in a walled-garden and real-time monitoring of, and data collection within, that environment), and with its training and logic engine and lesson task checker (which will assess right/wrong, complete/incomplete). Each of these facets adapts to the specific requirements of a situation. With the same engine it can adapt to various scenarios, including, but not limited to: learning, certification, screening, skills assessment, product evaluation, data collection, automation (templatizing tasks).

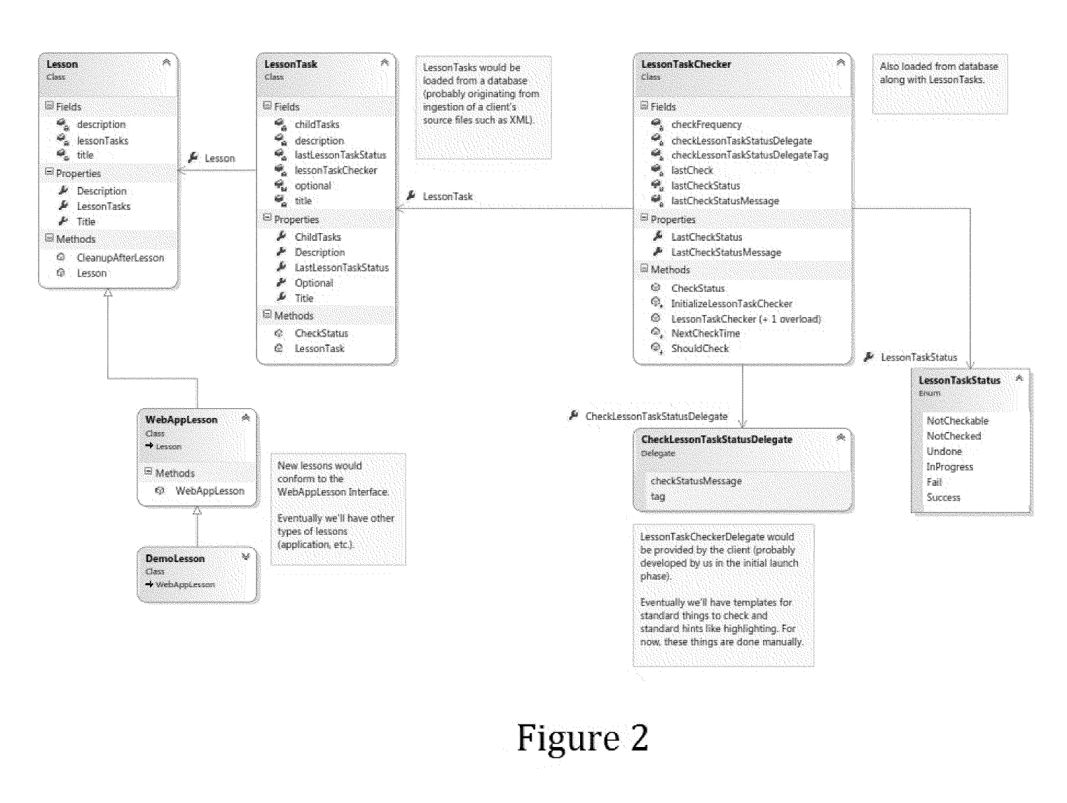

The platform 1 can control, customize, and manage data collection and activity monitoring. Its architecture is shown in FIG. 2.

It has a logic engine and lesson task checker that can assess right/wrong, complete/incomplete, and it can track path to completion and whether the user has adhered to best practices. Higher level tasks can be broken down into specific tasks and activities. The engine allows for as much granularity of tasks as needed. Tasks can be nested and can have internal dependencies. It can attach lesson checkers/logic units to each task.

Its content interface allows the platform to integrate with content management systems (CMS). The platform 1 can ingest content from a CMS and generate compliant content that will operate in user's environment. It can also manage, track, and update that content via automated processes.

The walled garden approach allows it to present an actual live running environment, but controls the environment, and limits or constrains the ability of a user to perform certain tasks or to access certain elements of the non-walled environment. This allows for a controlled user experience, prevents the user from performing tasks that could negatively impact a critical production environment, while still allowing direct real-time experience within the live environment.

It can present the application/environment via a browser or via other interfaces. It can present context sensitive instructional content side-by-side with the live environment, and that is linked directly to the user's activity in the live environment. It can pro-actively guide the user based on the task they are trying to achieve and where they are in the process. Overlay prompts in the live environment let the system “light up” UI elements to prompt the user as to where they need to click next. These types of prompts ensure that the user will not get lost, and that they adhere to a prescribed path.

User entry and user account provisioning is automated and if user accounts are required they are processed in an automated fashion behind the scenes. Environment setup and teardown is done in an efficient, automated manner. When the user is finished with the learning experience, the environment is—in the case of software applications—torn down so that no legacy objects or elements are retained. It also has the ability to preserve the environment if a user wishes to take what they have built with them, or to export it to a production environment.

The platform 1 has the ability to sense where the user is in a task or objective and provide guidance and feedback to the user, and provide corrective action as needed. Tasks are clearly represented as complete when a user has achieved a task or objective goal. This can be achieved via color-coding or other visual or audible feedback. The logic engine allows for non-sequential completion of tasks. As long as an objective is completed, it allows for asynchronous task completion within that objective. Also, it allows for numerous paths or methods for task completion. With the intent of being illustrative and not limiting, in the case of a web-offered service, a user might be able to complete a task via a graphical UI or via coding/scripting. The engine will accept either method, and will provide the same level of feedback, task-checking, and assessment regardless of the method used.

The platform 1 has the ability to assign different weighting to different tasks within an objective. It can also identify best-practice route to completion, and assign higher weighting to the correct method. Its administrative module allows a system administrator to set up, design, and attach weighting to tasks, objectives, and lessons. Administrators can set dependencies between tasks, objectives, and lessons. They can attach time limits. They can determine how much—if any—context sensitive help/guidance is offered to the user.

The platform 1 has the ability to filter latency that is not directly attributable to the user. For example, if the live system being used relies on web connectivity, and the user has a high latency connection, it can filter out the delay associated with the connection, and isolate the amount of time it truly took the user to accomplish a task. Similarly, if for example the user is in a web-services environment and that environment is experiencing latency, it can filter out system latency so it does not pollute the true measure of the user's efficiency in completing a task or set of tasks.

With the intent of being illustrative and not limiting, presented below are a few potential applications and use cases for this technology:

Training—In-application training

Testing—Real-time testing in a live environment with the ability to assess successful task and objective completion and best practice use.

Certification—The system can deliver a broken environment to the user, or code containing bugs needing to be fixed, and assess their ability to remedy these in real-time. It can turn off context sensitive help/guidance and simply present a tasks or set of tasks that the user needs to complete within a specified time limit.

Developer/coder—A programmer can be asked to write code that performs specific actions on a software environment, or asked to fix existing code. The system can assess and judge whether the code achieved the desired objective. Efficient, less complicated code, or code that is executed according to best practices, can be given a higher score.

HR-Recruiting/screening—The system will allow recruiters or recruiting sites assess the highest quality resources based on performance of tasks and objectives according to best practices.

Product Evaluation/Demonstration—The system will allow new users to walk through a live environment with direction and guidance, and can collect data on how the user interacted with the system, where they ran into problems or difficulties, and how long they spent using various areas of the system.

Help systems—The platform changes how help systems work. As opposed to delivering static generic content for everyone, the system delivers goal oriented interactive help in the actual live environment.

Automated vehicles—The engine can power a training and testing environment for automated cars. By collecting data about how people are driving, the mistakes they're making, and what's going on around them, it can see how they are performing; how well did they parallel park (i.e. how many actions it took to achieve the goal), did they obey speed limit, etc.

Dance competition—Using input from a pattern recognition system. Right/wrong checking is done by comparing what the contestant is doing to whatever the administrator has set as right or wrong.

### Automation and Content Generation

The system will allow for the generation of, for example, working code. When a user has successfully completed a set of tasks or objectives, they can take what they have created and export it for use in production environments. For example, in the case of hosted Web Services, it can automate the creation of instances, load balancers, etc.

Authoring content—In recording mode, the system allows an administrator to use a live environment to show best practice method to complete a task by actually doing the task or tasks in real time. This will generate the content for the lesson which can then be delivered to students as an exercise.

### Predictive Feedback

After a user has interacted with the platform's system numerous times, and based on the data collected, it has the ability to predict what a person is trying to do and anticipate where they are most likely to have problems. It can then deliver prescriptive guidance and feedback to the user.

### User Management and Tracking

User management can be achieved via its LMS and user tracking database. It can also interface with other user account systems/databases, whether they are proprietary or provided via social networking IDs (Linkedln™, etc). The system uses SSO (single sign on) to authenticate users.

### Data Collection, Reporting and Metrics

The system can collect data about the user and exactly what they do in the environment to a very granular level. The data it collects can be used for many purposes, including testing and certification. It can track tasks completed, time per task, path to completion (best practice vs. alternate path), method of completion, etc. The data it collects can also inform product development/design. It also provides customizable reporting so a system administrator can pull only the relevant data they want and need from the system.

### SDK

Its SDK allows application developers to develop content and exercises that will function on the platform 1.

The ActiveTraining environment is a rich platform for experiential learning in live environments where constant real-time feedback informs the platform's application as well as the user/administrator and delivers a guided, self-improving, iterative learning experience with numerous practical applications.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A system comprising; a platform with an engine with a real-time link between a live environment and the engine where the engine will plug in and adapt to different scenarios.

2. The system as defined in claim 1, wherein said scenarios, include one of more of a set of learning, certification, skills assessment, data collection, and automation.

3. The system as defined in claim 1, wherein said platform has a walled garden approach.

4. The system as defined in claim 3, wherein said walled garden approach allows the platform to present an actual live running environment, but controls the environment.

5. The system as defined in claim 4, wherein said platform limits the ability of a user to perform certain tasks or to access certain elements of the non-walled environment.

6. The system as defined in claim 5, wherein said platform prevents a user from performing tasks that could negatively impact a critical production environment, while allowing direct real-time experience within a live environment

7. The system as defined in claim 1, wherein said platform controls, customizes, and manages data collection and activity monitoring.

8. The system as defined in claim 1, wherein said platform has a logic engine and lesson task checker that assesses right/wrong, complete/incomplete.

9. The system as defined in claim 8, wherein said platform tracks a path to completion.

10. The system as defined in claim 8, wherein said platform tracks if the user has adhered to best practices.

11. The system as defined in claim 8, wherein higher level tasks can be broken down into specific tasks and activities.

12. The system as defined in claim 8, wherein said engine attaches lesson checkers/logic units to each task.

12. The system as defined in claim 1, wherein said platform can present the application/environment via interfaces.

13. The system as defined in claim 1, wherein said platform can present context sensitive instructional content side-by-side with the live environment, and that is linked directly to the user's activity in the live environment.

14. The system as defined in claim 1, wherein said platform can pro-actively guide the user based on the task they are trying to achieve and where they are in the process.

15. The system as defined in claim 14, wherein overlays in the live environment “light up” UI elements to prompt the user as to where they need to click next.

16. The system as defined in claim 14, wherein said user is notified if they are done with a task.

17. The system as defined in claim 8, wherein said engine allows for non-sequential completion of tasks.

18. The system as defined in claim 1, wherein said platform filters latency that is not attributable to the user.

19. The system as defined in claim 1, wherein said platform assigns different weighting to different tasks within an objective.

20. A system comprising; a platform with an engine with a real-time link between a live environment and the engine where the engine will plug in and adapt to different scenarios, where said platform was a walled garden approach which allows the platform to present an actual live running environment, but controls the environment and limits the ability of a user to perform certain tasks or to access certain elements of the non-walled environment, wherein said platform controls, customizes, and manages data collection and activity monitoring, wherein said platform has a logic engine and lesson task checker that assesses right/wrong, complete/incomplete, where said platform tracks a path to completion and whether the user has adhered to best practices, where higher level tasks can be broken down into specific tasks and activities, where said platform can present context sensitive instructional content side-by-side with the live environment, and that is linked directly to the user's activity in the live environment, where said platform can pro-actively guide the user based on the task they are trying to achieve and where they are in the process.
